(19) United States
(12) Patent Application Publication
(10) Pub. No.: US 2026/0162323 A1
(43) Pub. Date: Jun. 11, 2026

(54) VIRTUAL DIAGRAM GENERATION

(71) Applicant: INTERNATIONAL BUSINESS MACHINES CORPORATION, ARMONK, NY (US)

(72) Inventors: Arkadiy O. Tsfasman, Wappinger Falls, NY (US); John S. Werner, Fishkill, NY (US); Logan Bailey, Atlanta, GA (US); Zachary Augustus Silverstein, Georgetown, TX (US)

(21) Appl. No.: 18/973,832

(22) Filed: Dec. 9, 2024

(51) Int. Cl. G06T 11/20; G10L 15/06; G10L 15/08

(52) U.S. Cl. CPC G06T 11/26; G10L 15/063; G10L 15/08

(57) ABSTRACT

Aspects of the present disclosure relate to virtual diagram generation and management. Speech data can be obtained from a speaker within a web conference. A set of key phrases can be extracted from the speech data within the web conference based on a first set of user data associated with a first user. A virtual diagram can be generated using the set of key phrases, wherein the virtual diagram is generated based on the first set of user data. The virtual diagram can be caused to be displayed to the first user within the web conference.

### BACKGROUND

The present disclosure relates generally to the field of computing, and in particular, to virtual diagram generation.

Web conferencing software facilitates communication between individuals online via transmission of audio/video (A/V) data of the individuals in real-time over a network.

### SUMMARY

Embodiments of the present disclosure are directed to a method, system, and computer program product for virtual diagram generation. Speech data of a speaker within a web conference can be obtained. A set of key phrases can be extracted from the speech data based on a first set of user data associated with a first user. A virtual diagram can be generated using the set of key phrases, where the virtual diagram is generated based on the first set of user data. The virtual diagram can be caused to be displayed to the first user within the web conference.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 is a high-level block diagram illustrating an example computer system and network environment that can be used in implementing one or more of the methods, tools, modules, and any related functions described herein, in accordance with embodiments of the present disclosure.

FIG. 2 is a block diagram illustrating an example network environment, in accordance with embodiments of the present disclosure.

FIG. 3 is a diagram depicting a computing environment including a virtual diagram management system, in accordance with embodiments of the present disclosure.

FIG. 4 is a flow-diagram illustrating a method for speech based virtual diagram generation, in accordance with embodiments of the present disclosure.

FIG. 5 is a flow-diagram illustrating another method for speech based virtual diagram generation, in accordance with embodiments of the present disclosure.

FIG. 6 is a flow-diagram illustrating a method for training a machine learning model for speech based virtual diagram generation, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of computing, and more particularly, to virtual diagram generation. While the present disclosure is not necessarily limited to such applications, various aspects of the disclosure may be appreciated through a discussion of various examples using this context.

Web conferencing software facilitates communication between individuals online via transmission of audio/video (A/V) data of the individuals in real-time over a network. In the realm of virtual communication, web conferences have become a staple for organizations and teams to share knowledge, collaborate, and present ideas. However, much of the content shared during these sessions remains text or speech heavy, relying on notes, static pages, or extended discussions that are not visually engaging. As a result, users may struggle to fully comprehend or retain information presented in these formats. The lack of graphical representation can significantly diminish the effectiveness of communication, particularly when attempting to convey complex ideas, trends, or data.

A challenge lies in transforming information shared during web conferences into more digestible and impactful formats. Without visual aids, presentations often lose their ability to captivate and clarify key points. Current solutions require individuals to manually convert discussions into visual representations, whether in the form of charts, infographics, or other graphic elements—adding a layer of work and potential delay. This approach not only makes it difficult for users to stay engaged in real-time, but also limits the usability of the content for future reference or asynchronous consumption. As such, there is a clear need for streamlined tools or methods that can automatically enhance web conference content with visual elements.

Embodiments of the present disclosure are directed to speech based virtual diagram management. Speech data of a speaker within a web conference can be obtained. A set of key phrases can be extracted from the speech data based on a first set of user data associated with a first user. A virtual diagram can be generated using the set of key phrases, wherein the virtual diagram is generated based on the first set of user data. The virtual diagram can be caused to be displayed to the first user within the web conference. In embodiments, the extracting and generating can be completed by respective machine learning models.

Aspects of the present disclosure address the aforementioned complications by enabling dynamic real-time generation of virtual diagrams based on spoken utterance with web conferences. Key phrases can be extracted from speech data based on user data associated with respective users. Thus, content (e.g., speech topics) that is relevant to respective users can be included in respective virtual diagrams. As such, aspects of the present disclosure enhance usability of web conferencing technologies by enabling the generation of personalized virtual diagrams. Further, the virtual diagrams can be generated based on style preferences (e.g., font, color, and diagram type) of each user. Accordingly, the barrier to comprehension within web conferences or other virtual meetings can be significantly reduced. Such technology enables real-time transformation of discussions into visually rich presentations, making the content more engaging and accessible both during the web conference and in post web conference reviews. This provides users with a more consumable and value-driven experience, ultimately fostering better retention, understanding, and usage of the material shared.

Further, as extraction of key phrases and generation of virtual diagrams can be completed using one or more trained machine learning models, the key phrases that are extracted for respective users as well as the diagrams generated for respective users are more likely to match each respective user's preferences. Aspects of the present disclosure enable models for key phrase extraction and virtual diagram generation to be trained over time, thereby enhancing the accuracy that extracted key phrases and generated virtual diagrams match user preferences.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

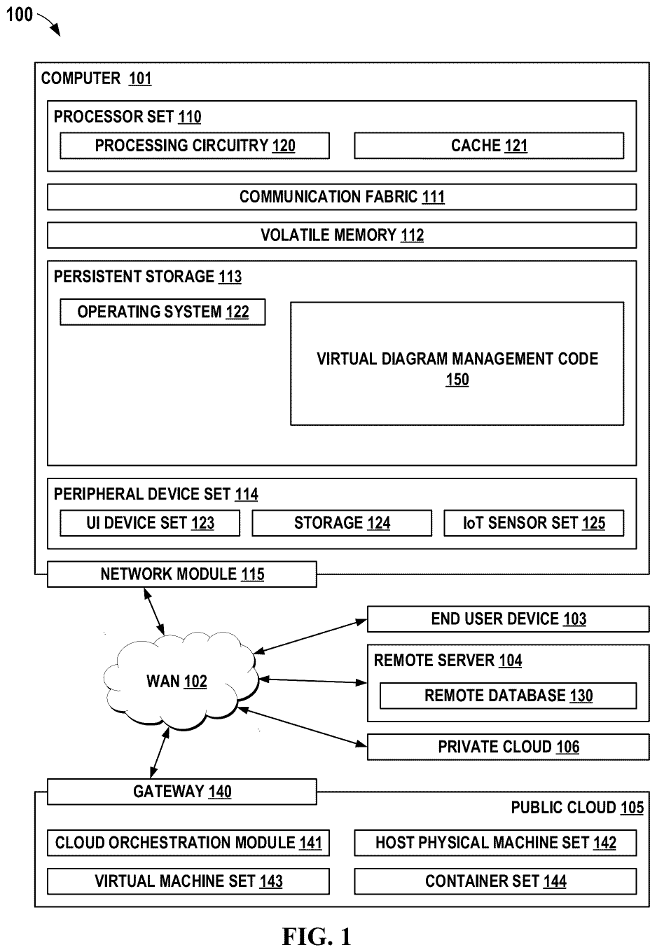

FIG. 1 is a high-level block diagram illustrating an example computing environment 100 that can be used in implementing one or more of the methods, tools, modules, and any related functions described herein, in accordance with embodiments of the present disclosure. Computing environment 100 contains an example of an environment for the execution of at least some of the computer code involved in performing the inventive methods, such as virtual diagram management code 150. In addition, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and virtual diagram management code 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some or all of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in virtual diagram management code 150 in persistent storage 113.

Communication fabric 111 includes the signal conduction paths that allow the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in virtual diagram management code 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, mixed reality (MR) headset, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

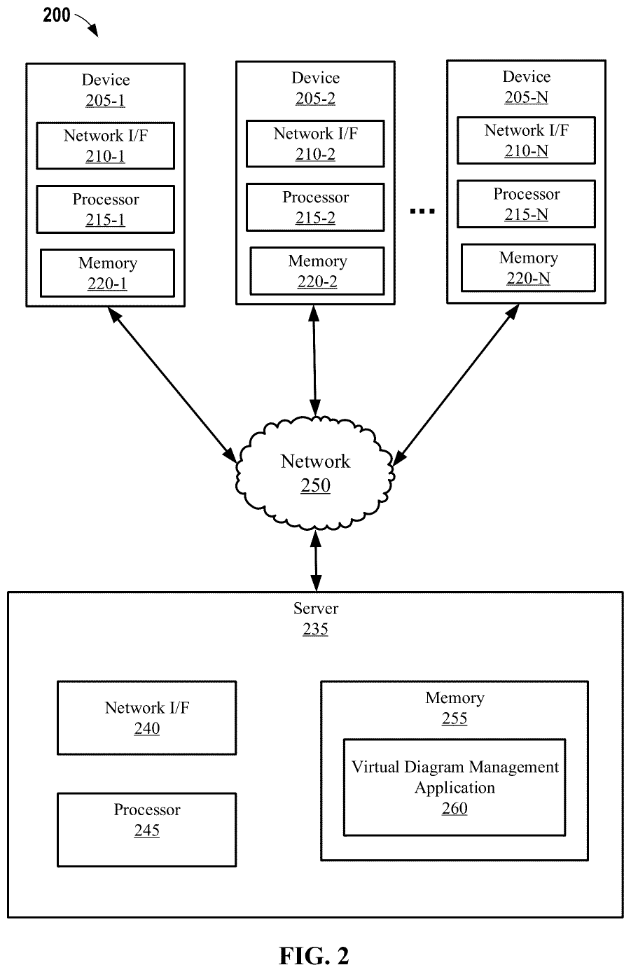

FIG. 2 is a block diagram illustrating an example computing environment 200 in which illustrative embodiments of the present disclosure can be implemented. Computing environment 200 includes a plurality of devices 205-1, 205-2, . . . , 205-N (collectively devices 205), at least one server 235, and a network 250.

The devices 205 and the server 235 include one or more processors 215-1, 215-2, . . . , 215-N (collectively processors 215) and 245 and one or more memories 220-1, 220-2, . . . , 220-N (collectively memories 220) and 255, respectively. The processors 215 and 245 can be the same as, or substantially similar to, processor set 110 of FIG. 1. The memories 220 and 255 can be the same as, or substantially similar to volatile memory 112 and/or persistent storage 113 of FIG. 1.

The devices 205 and the server 235 can be configured to communicate with each other through internal or external network interfaces 210-1, 210-2, . . . , 210-N (collectively network interfaces 210) and 240. The network interfaces 210 and 240 are, in some embodiments, modems or network interface cards. The network interfaces 210 and 240 can be the same as, or substantially similar to, network module 115 described with respect to FIG. 1.

The devices 205 and/or the server 235 can be equipped with a display or monitor. Additionally, the devices 205 and/or the server 235 can include optional input devices (e.g., a keyboard, mouse, scanner, a biometric scanner, video camera, or other input device), and/or any commercially available or custom software (e.g., web conference software, browser software, communications software, server software, natural language processing software, search engine and/or web crawling software, image processing software, augmented reality/virtual reality (AR/VR) software, artificial intelligence (AI) software), etc.). For example, devices 205 and/or server 235 can be, or include, components/devices such as those described with respect to peripheral device set 114 of FIG. 1. The devices 205 and/or the server 235 can be servers, desktops, laptops, vehicles, edge computing nodes, or hand-held devices. The devices 205 and/or the server 235 can be the same as, or substantially similar to, computer 101, remote server 104, and/or end user device 103 described with respect to FIG. 1.

The devices 205 and the server 235 can be distant from each other and communicate over a network 250. In some embodiments, the server 235 can be a central hub from which devices 205 can establish a communication connection, such as in a client-server networking model. Alternatively, the server 235 and devices 205 can be configured in any other suitable networking relationship (e.g., in a peer-to-peer (P2P) configuration or using any other network topology).

In some embodiments, the network 250 can be implemented using any number of any suitable communications media. In embodiments, the network 250 can be the same as, or substantially similar to, WAN 102 described with respect to FIG. 1. For example, the network 250 can be a wide area network (WAN), a local area network (LAN), an internet, or an intranet. In certain embodiments, the devices 205 and the server 235 can be local to each other and communicate via any appropriate local communication medium. For example, the devices 205 and the server 235 can communicate using a local area network (LAN), one or more hardwire connections, a wireless link or router, or an intranet. In some embodiments, the devices 205 and the server 235 can be communicatively coupled using a combination of one or more networks and/or one or more local connections. For example, the first device 205-1 can be hardwired to the server 235 (e.g., connected with an Ethernet cable) while the second device 205-2 can communicate with the server 235 using the network 250 (e.g., over the Internet).

In some embodiments, the network 250 is implemented within a cloud computing environment or using one or more cloud computing services. Consistent with various embodiments, a cloud computing environment can include a network-based, distributed data processing system that provides one or more cloud computing services. Further, a cloud computing environment can include many computers (e.g., hundreds or thousands of computers or more) disposed within one or more data centers and configured to share resources over the network 250. In embodiments, network 250 can be coupled with public cloud 105 and/or private cloud 106 described with respect to FIG. 1.

The server 235 includes a virtual diagram management application (VDMA) 260. The VDMA 260 can be configured to generate virtual diagrams based on speech data (e.g., obtained from a web conference). The virtual diagrams can be personalized for specific users based on the same, or a different, set of speech data. In embodiments, the VDMA 260 can cause one or more virtual diagrams to be displayed to participants within a web conference. While exemplary embodiments reference implementation in web conferences, aspects of the present disclosure can be implemented in any scenario involving speech data. Further, while exemplary embodiments reference the generation and management of virtual diagram based on speech data, in embodiments, virtual diagrams can be generated based on other data associated with a web conference (e.g., text within a presentation, existing graphics within a document, or other data associated with conversation topics).

VDMA 260 can be configured to collect, request, or otherwise obtain speech data. Speech data refers to spoken utterances of users, which may be obtained from audio/video (A/V) data of, for example, a web conference. In embodiments, the speech data can be obtained from microphones of users (e.g., in real-time) and converted into text or another format for subsequent processing (e.g., using natural language processing (NLP) techniques). In embodiments, speech data can be obtained from a saved audio file (e.g., a saved recording of a web conference). Speech data can be collected over any suitable timing, including continuously (e.g., speech data can be collected for all utterances obtained/recognized within a web conference), intermittently, periodically, and/or based on specific triggers (e.g., key words that cause collection of speech data for use by VDMA 260).

In addition to obtaining speech data, other data may be collected, such as text-based data associated with a document (e.g., a document being presented in a web conference, such as a presentation or word document), graphical data, or other data to be used for virtual diagram generation and management.

As discussed herein, VDMA 260 can be configured to be implemented within web conferences. Web conferencing software facilitates communication between individuals online via transmission of audio/video (A/V) data of the individuals in real-time over a network. For example, existing web conferencing software that embodiments can be implemented in include CISCO WEBEX®, MICROSOFT TEAMS®, ZOOM®, etc. In embodiments, server 235 can be a web conferencing server configured to execute the functionalities of the VDMA 260. In embodiments, the server 235 can interface a web conferencing server (not shown) to utilize functionalities of the VDMA 260.

VDMA 260 can be configured to obtain user data. User data can be collected for the purpose of personalizing virtual diagrams based on specific participant characteristics. For example, user data that can be used to aid in virtual diagram generation and management include user roles, user experience, user diagram preferences (e.g., preferred diagram types, preferred color schemes, preferred font characteristics, etc.), application data (e.g., user application preferences, installed applications, etc.), and other data. VDMA 260 can be configured to collect user data over network 250 from devices associated with specific users (e.g., devices 205).

The VDMA 260 can be configured to extract key phrases from speech data associated with a web conference. A set of key phrases can refer to a subset of the speech data that is determined to be relevant to a particular user or group of users based on data associated with the user(s) for the purpose of virtual diagram generation. While key phrases used for the purpose of virtual diagram generation can be extracted directly from speech data, in embodiments, key phrases can additionally or alternatively be extracted from presentation material, such as text-based documents, graphics, and presentation documents. In embodiments, key phrases are extracted from text associated with a speech-to-text conversion of speech data. Extracted key phrases can be utilized to facilitate the generation of virtual diagrams to be presented to one or more users.

Key phrases can be extracted from speech/textual data for specific users or for groups of users. As an example, a first set of extracted key phrases can be utilized to generate a first virtual diagram for a first user. As another example, a second set of extracted key phrases can be utilized to generate a second virtual diagram for a first group of users. As another example, a third set of key phrases can be utilized to generate a third virtual diagram for a second user. The extracted key phrases for respective users or user groups can be based on the same speech data (e.g., obtained from the same speaker(s)). Different users and/or user groups can have different virtual diagrams presented thereto during the course of a live web conference.

In embodiments, key phrase extraction can be initiated in response to a condition. For example, key phrase extraction can be completed in response to specific speech utterances (e.g., “I need a graphical explanation,” “Here are the statistics for . . . ,” “First we do “X,” then we do “Y,” etc.). In embodiments, key phrase extraction can be completed in response to a user request (e.g., a graphical user interface (GUI) controls can be used by users to initiate key phrase extraction for virtual diagram management). In embodiments, key phrase extraction for virtual diagram management can be initiated upon completion of a web conference (e.g., in a batch fashion) using stored speech data (e.g., a web conference recording). In embodiments, a machine learning (ML) model, such as a key phrase extraction ML model or automatic summarization ML model, can be utilized to extract key phrases from speech, text, and/or graphical data for virtual diagram management.

The VDMA 260 can be configured to generate virtual diagrams using the extracted key phrases. Virtual diagrams are software-based (e.g., digital) graphical diagrams that are generated based on extracted key phrases. In embodiments, one or more generative ML models can be implemented to automatically generate virtual diagrams based on input key phrases for presentation to users. In embodiments, virtual diagrams can be generated in an image format (e.g., jpeg). In embodiments, virtual diagrams can be generated in a diagrammatic format (e.g., vsd, vdx, XML Schema-based formats, etc.) dependent on implemented diagramming software the VDMA 260 has access to. The generative ML models used to generate virtual diagrams can be implemented client-side (e.g., on clients 355), on server 235, or from another source (not shown) utilized over network 250. Examples of virtual diagrams that can be generated using extracted key phrases include organizational charts, diagrams, flowcharts, histograms, scatter plots, 3D graphs, pictographs, Gantt charts, mind maps, Venn diagrams, trees, ontological structures, and other types of diagrams.

The VDMA 260 can be configured to generate virtual diagrams for respective users or user groups. The types of generated virtual diagrams, and the content depicted therein, can depend on user data associated with respective users for which virtual diagrams are to be generated for. For example, the type of virtual diagram generated for a programmer can differ from the type of virtual diagram generated for a sales representative. Further, the content that a programmer desires to have visualized can also differ from the content that a sales representative desires to have visualized. Thus, key phrases extracted for virtual diagram generation for specific individuals (e.g., a programmer versus a sales representative) can differ. Similarly, the type and format of generated virtual diagrams can differ based on user data associated with specific individuals.

The VDMA 260 can be configured to cause virtual diagrams to be displayed to users (e.g., participants of a web conference). The VDMA 260 can be configured to cause virtual diagrams to be shared via integration into presentation materials that are screen shared, via display within a web conferencing application, via one or more client-side applications (e.g., a multimedia application or diagramming application), or in any other suitable manner. Virtual diagrams can be generated and displayed to specific users or user groups at discrete timings. In embodiments, virtual diagrams can be generated/displayed in real-time or upon conclusion of a web conference. In embodiments, virtual diagrams can be populated in real-time. That is, a virtual diagram may begin to be displayed to a user before it is completed (e.g., flowchart steps may be incrementally added while a conversation is occurring during a web conference). In embodiments, virtual diagrams can be presented to users in a finalized form (e.g., a flowchart is presented to a user after discussing a given process). However, any suitable manner for presenting virtual diagrams to users can be implemented without departing from the spirit and scope of the present disclosure.

It is noted that FIG. 2 is intended to depict the representative major components of an example computing environment 200. In some embodiments, however, individual components can have greater or lesser complexity than as represented in FIG. 2, components other than, or in addition to, those shown in FIG. 2 can be present, and the number, type, and configuration of such components can vary.

While FIG. 2 illustrates a computing environment 200 with a single server 235, suitable computing environments for implementing embodiments of this disclosure can include any number of servers. The various models, modules, systems, and components illustrated in FIG. 2 can exist, if at all, across a plurality of servers and devices. For example, some embodiments can include two servers. The two servers can be communicatively coupled using any suitable communications connection (e.g., using a WAN 102, a LAN, a wired connection, an intranet, or the Internet).

Though this disclosure pertains to the collection of personal data (e.g., user data and speech data), it is noted that in embodiments, users opt into the system. In doing so, they are informed of what data is collected and how it will be used, that any collected personal data may be encrypted while being used, that the users can opt-out at any time, and that if they opt out, any personal data of the user is deleted.

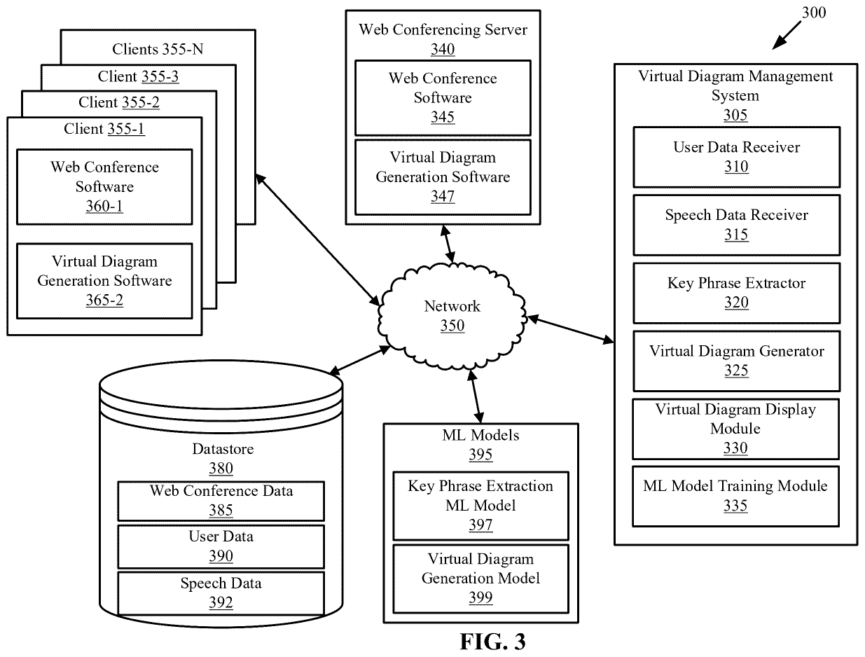

Referring now to FIG. 3, shown is a block diagram illustrating an example network environment 300 in which illustrative embodiments of the present disclosure can be implemented. The network environment 300 includes a virtual diagram management system (VDMS) 305, a web conferencing server 340, client 355-1, client 355-2, client 355-3 . . . client 355-N (e.g., collectively clients 355), a datastore 380, and machine learning (ML) models 395, each of which can be communicatively coupled for intercomponent interaction via a network 350. In embodiments, the network 350 can be the same as, or substantially similar to, network 250 and/or WAN 102. In embodiments, the VDMS 305, web conferencing server 340, and/or clients 355 can be the same as, or substantially similar to, computer 101, peripheral device set 114, end user device 103, devices 205, and/or server 235. In embodiments, datastore 380 and/or ML models 395 can be integrated with one or more components of FIG. 3 or other components not shown in FIG. 3 (e.g., ML models 395 may execute on a server not shown in FIG. 3).

The VDMS 305 can be configured to generate virtual diagrams based on speech data (e.g., obtained from a web conference running on web conferencing software 345). The virtual diagrams can be personalized for specific users. In embodiments, the VDMS 305 can cause one or more virtual diagrams to be displayed to participants within a web conference. While exemplary embodiments reference implementation in web conferences, aspects of the present disclosure can be implemented in any scenario involving speech data. Further, while exemplary embodiments reference the generation and management of virtual diagram based on speech data, in embodiments, virtual diagrams can be generated based on other data associated with a web conference, such as text within presentation material, existing graphics within a document, or other data associated with conversation topics within a web conference.

The clients 355 can each be the same as, or substantially similar to, computer 101 described with respect to FIG. 1. That is, the clients 355 can include one or more processors and/or memories and can be configured to communicate with other components over network 350. The clients 355 each include web conferencing software 360. Each client 355 can communicate with web conference server 340 to facilitate web conferencing via web conferencing software 345 hosted by the web conference server 340. Any suitable number of clients 355 can establish communication with web conference server 340 to participate in web conferences. The web conferencing software 345 hosted by web conference server 340 can facilitate the sharing of shared content by clients 355. Thus, clients 355 can share content, such as images, videos, audio data, and the like, over network 350 via web conferencing software 345 and 360. Web conferencing offers real-time point-to-point communications from one sender to many receivers. Web conference services allow text, audio, and/or video data to be shared simultaneously across geographically dispersed locations. In some embodiments, a web conference server 340 may not be implemented, as the web conference can be hosted by a client or another system. Web conferencing software 360 can be browser-based or application-based software.

The VDMS 305 includes a user data receiver 310, speech data receiver 315, key phrase extractor 320, virtual diagram generator 325, virtual diagram display module 330, and ML model training module 335. The functionalities of the user data receiver 310, speech data receiver 315, key phrase extractor 320, virtual diagram generator 325, virtual diagram display module 330, and ML model training module 335 can be processor-executable instructions that can be executed by a dedicated or shared processor using received inputs.

Speech data receiver 315 can be configured to obtain speech data 392. Speech data 392 includes utterances from different users (e.g., speakers) within a web conference or within an audio file. While speech data 392 is shown as being stored in datastore 380, in embodiments, speech data 392 can be stored on clients 355, on web conferencing server 340, and/or on VDMS 305. In embodiments, the speech data 392 can be obtained from microphones of users (e.g., in real-time) and converted into text or another format for subsequent processing (e.g., using natural language processing (NLP) techniques). In embodiments, speech data 392 can be obtained (e.g., extracted) from a saved audio file (e.g., a saved recording of a web conference). Speech data 392 can be collected over any suitable timing, including continuously (e.g., speech data can be collected for all utterances obtained/recognized within a web conference), intermittently, periodically, and/or based on specific triggers (e.g., key words that cause collection of speech data 392 for use by VDMS 305). In embodiments, pre-processing of speech data 392 can include applying one or more techniques for noise reduction, normalization, and/or feature extraction, among other types of pre-processing.

The user data receiver 310 can be configured to obtain user data 390. User data 390 can be used for the purpose of personalizing virtual diagrams for specific users within a web conference. Exemplary types of user data 390 that may be obtained for the purpose of virtual diagram generation include names, locations, roles, experience levels, font preferences, color scheme preferences, diagram preferences, interests, application preferences, and historical computing data (e.g., browsing and application data). User data 390 can be used for personalizing extracted key phrases and/or personalizing virtual diagram generation. Thus, key phrase extractor 320 may use user data 390 as an input for determining key phrases to be extracted for specific users. Similarly, virtual diagram generator 325 may use user data 390 as an input for generating virtual diagrams for specific users. As an example, key phrase extractor 320 can utilize a first role of the user (e.g., engineer) to identify specific key phrases that may be relevant to the first role of the user, while virtual diagram generator 325 can use user preferences for font (e.g., Times New Roman), color scheme (e.g., black and white), and diagrams (e.g., flow-charts) to generate a virtual diagram in accordance with the user's preferences.

While this disclosure pertains to the collection of personal data (e.g., user data 390 and speech data 392), it is noted that in embodiments, users opt into the system. In doing so, they are informed of what data is collected and how it will be used, that any collected personal data may be encrypted while being used, that the users can opt-out at any time, and that if they opt out, any personal data of the user is deleted.

Key phrase extractor 320 can be configured to extract key phrases from speech data to be used for the purpose of virtual diagram generation. A set of key phrases can refer to a subset of the speech data 392 that is determined to be relevant to a particular user or group of users based on user data 390 associated with the user(s) for the purpose of virtual diagram generation. While key phrases used for the purpose of virtual diagram generation can be extracted directly from speech data 392, in embodiments, key phrases can additionally or alternatively be extracted from web conference data 385, such as from presentation material (e.g., text-based documents, graphics, and embedded videos) of shared content. In embodiments, key phrases are extracted from text associated with a speech-to-text conversion of speech data 392. Extracted key phrases can be utilized to facilitate the generation of virtual diagrams to be presented to one or more users.

Key phrases can be extracted from speech/textual data for specific users or for groups of users based on user data 390. As an example, a first set of extracted key phrases, extracted based on a first user role (e.g., software development), can be utilized to generate a first virtual diagram for a first user group (e.g., software development team). As another example, a second set of extracted key phrases, extracted based on a second user role (e.g., project management), can be utilized to generate a second virtual diagram for a second group of users (e.g., project management team). As another example, a third set of key phrases, extracted based on a third user role (e.g., finance), can be utilized to generate a third virtual diagram for a third group of users (e.g., finance team). Thus, different sets of key phrases can be extracted for different users and/or user groups based on one or more user data 390 types. Key phrases can be extracted based on user data 390 types such as user roles, locations, applications preferences, and historical computing data, among other types of data. In embodiments, the key phrases extracted for respective users or user groups can be based on the same speech data (e.g., obtained from the same speaker(s) and from a same web conference). Different users and/or user groups can have different virtual diagrams presented thereto during the course of a live web conference based on distinct sets of key phrases. In embodiments, even if two given users have the same set of key phrases extracted from speech data 392 for virtual diagram generation, respective generated virtual diagrams can still differ (e.g., based on font, color, and diagram preferences).

In embodiments, key phrase extraction can be initiated in response to a condition. For example, key phrase extraction can be completed in response to specific speech utterances (e.g., “I need a graphical explanation,” “Here are the statistics for . . . ,” “First we do “X,” then we do “Y,” etc.). In embodiments, key phrase extraction can be completed in response to specific content recognized within a presentation, such as a text-heavy slide, a slide with only images, a slide with bullet points, etc. In embodiments, key phrase extraction can be initiated in response to a particular progress point within a presentation (e.g., at a particular slide or a specific amount of elapsed time). In embodiments, key phrase extraction can be completed in response to a user request (e.g., a graphical user interface (GUI) controls can be used by users to initiate key phrase extraction for virtual diagram management). In embodiments, key phrase extraction for virtual diagram management can be initiated upon completion of a web conference (e.g., in a batch fashion) using stored speech data (e.g., a web conference recording).

In embodiments, components of the VDMS 305, such as a key phrase extractor 320 and/or virtual diagram generator 325, can be configured to utilize ML models 395. Machine learning (ML) is a branch of AI that relates to constructing mathematical models that automatically learn and improve from experience without being explicitly programmed. That is, ML refers to techniques for training machines to perform specific AI tasks. ML training involves providing an ML algorithm with training data to learn from. Training can refer to the overall process of developing ML models 395, or the specific portion of the development process where parameters of the ML models 395 are updated. Training typically aims at finding a set of values of model parameters (e.g., weights) that best describe training data. In embodiments, ML model training module 335 of VDMS 305 can be configured to perform ML training of ML models 395.

Training can occur in a supervised manner, where the ML models 395 learn based on labeled training data. In supervised machine learning, a training dataset typically has labels for both inputs and corresponding output values. This enables the ML models 395 to learn functions that map inputs to outputs, thereby enabling the ML model 395 to make predictions on unseen data.

Training ML models 395 can also occur in a semi-supervised or unsupervised manner, where little to no labels are associated with training data the ML algorithm learns from. Unsupervised learning enables models to discover underlying patterns or structures (e.g., features used for predictions), such as clustering. In semi-supervised learning, a small amount of labeled data in combination with a large amount of unlabeled data can be injected during training, realizing the benefits of both supervised and unsupervised machine learning training methods.

Other manners for training ML models 395 are contemplated, such as reinforcement learning. Within reinforcement learning frameworks, ML models 395 learn by taking actions within an environment to maximize reward. This learning typically involves trial and error, where ML model 395 agents improve their policy over time based on feedback (e.g., reward and punishment) they receive after each action.

Training a ML model 395 can relate to performing direct training (e.g., where training is performed directly by one or more components of VDMS 305, such as ML model training module 335) or indirect training (e.g., where the VDMS 305 causes another system, component, application, etc. to perform training, for example, if ML model training module 335 is remotely located (not integrated within VDMS 305)). Thus, training an ML model 395 can refer to directly training an ML model 395 or otherwise causing the ML model 395 to be trained.

Hyperparameters and parameters of the ML model 395 to be trained can vary. Hyperparameters are a type of high-level parameter that controls a learning algorithm for the ML model 395. Hyperparameters are typically regarded as “external” to a ML model 395, as they control the training process, but are not affected during the training process. In contrast, ML model 395 parameters (as opposed to hyperparameters) can be updated during ML model 395 training. Values for hyperparameters and parameters can be set by an ML model administrator or engineer. These values can be updated over time based on trial and error, training processes, and/or via other algorithms (e.g., other ML models 395).

ML models 395 can include decision tree learning, association rule learning, artificial neural networks, deep learning, inductive logic programming, support vector machines, clustering, Bayesian networks, reinforcement learning, representation learning, similarity/metric training, sparse dictionary learning, genetic algorithms, rule-based learning, generative adversarial networks (GANs), and/or other machine learning techniques.

More specifically, the ML models 395 can utilize one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR), principal component analysis (PCA), principal component regression (PCR), Sammon mapping, t-distributed stochastic neighbor embedding (t-SNE), bootstrap aggregating, ensemble averaging, gradient boosted decision tree (GBRT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), Bayesian network (BN), classification and regression tree (CART), chi-squared automatic interaction detection (CHAID), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning techniques.

In embodiments, key phrase extractor 320 utilizes a key phrase extraction ML model 397 to facilitate key phrase extraction. Services of key phrase extraction ML model 397 can be provisioned over network 350 or alternatively integrated within VDMS 305. Key phrase extraction ML model 397 can include one or more models for extracting key phrases at specific timings and/or based on specific user data 390 for the purpose of generating virtual diagrams. The key phrase extraction ML model 397 can, in embodiments, be an ensemble model (e.g., a ML model comprising multiple ML pipelines) for processing speech and/or audio data. For example, the key phrase extraction ML model 397 can include a first ML model for processing speech data 392 (e.g., a speech-to-text conversion model) and a second ML model for extracting key phrases from the converted textual data for specific users/user groups based on user data 390 and in response to specific conditions (e.g., an automatic summarization model or key phrase extraction model). The key phrase extraction ML model 397 can be trained to extract key phrases for specific users in response to specific conditions. The key phrase extraction ML model 397 can additionally be trained to extract key phrases for specific users based on insights gleaned from user data 390. As discussed above, the training can be supervised, semi-supervised, unsupervised, and/or completed in a different manner, such as in a reinforcement learning framework, and can be executed by ML model training module 335.

As an example, the key phrase extraction ML model 397 can be trained to execute key phrase extraction based on user roles in a supervised manner. For example, sets of distinct key phrases can be extracted (e.g., manually by an ML model administrator or engineer) from a textual corpus (e.g., converted speech data) for respective user roles. The key phrases extracted for different user roles from the textual corpus can be provided to the key phrase extraction ML model 397 as labeled data for supervised learning. This can enable the key phrase extraction ML model 397 to learn from the labeled data such that it can perform automatic key phrase extraction based on user roles. Such supervised learning can be completed using any user data type, and is not necessarily limited to user roles. Further, key phrase extraction ML model 397 can alternatively be trained to perform key phrase extraction based on user data 390 in a semi-supervised manner, unsupervised manner, or using reinforcement learning. In embodiments, the key phrase extraction ML model 397 can be trained to extract key phrases from data other than speech data 392, such as data associated with presented content (e.g., textual data and/or graphics within a presentation document).

As another example, the key phrase extraction ML model 397 can be trained to execute key phrase extraction based on specific conditions and/or based on specific timings in a supervised manner. For example, sets of key phrases can be extracted based on specific conditions (e.g., keyword detection, presentation progress, based on recognized content), and/or at specific timings (e.g., intermittently, periodically, etc.) for different users and/or user groups during a live web conference. The key phrases extracted for different users/user groups at specific conditions and/or timings (e.g., as completed manually be an ML administrator) can be provided to the key phrase extraction ML model 397 as labeled data for supervised learning. This can enable the key phrase extraction ML model 397 to learn from the labeled data such that it can perform automatic key phrase extraction based on specific conditions and/or timings during a live web conference. Such supervised learning can be completed using any specific conditions or timings. Further, key phrase extraction ML model 397 can alternatively be trained to execute key phrase extraction at specific conditions and/or timings in a semi-supervised manner, unsupervised manner, or using reinforcement learning.

The virtual diagram generator 325 can be configured to generate virtual diagrams using key phrases extracted by the key phrase extractor 320. Virtual diagrams are software-based (e.g., digital) diagrams. Virtual diagrams can be generated in any suitable format. In embodiments, virtual diagrams can be generated in an image format (e.g., jpeg). In embodiments, virtual diagrams can be generated in a diagrammatic format (e.g., vsd, vdx, XML Schema-based formats, etc.) dependent on implemented diagramming software the virtual diagram generator 325 has access to. Examples of virtual diagrams that can be generated using extracted key phrases include organizational charts, diagrams, flowcharts, histograms, scatter plots, 3D graphs, pictographs, Gantt charts, mind maps, Venn diagrams, trees, ontological structures, and other types of diagrams. In embodiments, virtual diagram generator 325 can generate diagrams using virtual diagram generation software 365-2 of clients and/or virtual diagram generation software 347 of web conferencing server 340. The format that virtual diagrams are generated in can depend on the virtual diagram generation software 347 utilized by the virtual diagram generator 325.

Virtual diagram generator can be configured to generate different virtual diagrams for respective users or user groups. The types of generated virtual diagrams, and the content depicted therein, can depend on user data 390 associated with respective users for which virtual diagrams are to be generated for. For example, the type of virtual diagram generated for an implementation technician can differ from the type of virtual diagram generated for a sales associate. Further, the content that an implementation technician desires to have visualized can also differ from the content that a sales associate desires to have visualized. Thus, key phrases extracted for virtual diagram generation for specific individuals (e.g., an implementation technician versus a sales associate) can differ. Similarly, the type and format of generated virtual diagrams can differ based on user data 390 associated with specific individuals. For example, an implementation technician may have key phrases extracted that relate to implementation strategies of a given service/product for a client, while a sales associate may have key phrases extracted that relate to sales figures/statistics for a given product. Further, the implementation technician may have a virtual diagram generated in a virtual map format (depicting locations of infrastructure of a client) while a sales associate may have a virtual diagram generated in a chart format (e.g., a bar graph or pie chart depicting sales proportions for different products and/or for different geographic locations). Thus, the virtual diagram generator 325 can be configured to generate a variety of different types of virtual diagrams, within any suitable format, based on extracted key phrases relevant to specific individuals.

In embodiments, a virtual diagram generation model 399 of ML models 395 can be trained (e.g., by ML model training module 335) to automatically generate virtual diagrams based on extracted key phrases for presentation to users. While depicted as stored within ML models 395, in embodiments, virtual diagram generation model 399 can be implemented client-side (e.g., on clients 355), on VDMS 305, on web conferencing server 340, or be accessed from another source over network 350.

The virtual diagram generation module 399 can be a generative ML model configured to generate virtual diagrams based on extracted key phrases from speech data 392 and based on user data 390 associated with respective users. The virtual diagram module 399 can be or include large language models (LLMs), generative adversarial network (GAN) models, text-to-image models, deep neural networks, and latent diffusion models, among others. In embodiments, virtual diagram generation module 399 combines language models which transform input text (e.g., extracted key phrases) into a latent representation and a generative image model which produces images based on latent representations of text. The virtual diagram generation module 399 can be trained in a supervised, semi-supervised, unsupervised, or reinforcement learning framework, for example, by ML model training module 335.

In embodiments, the virtual diagram generation module 399 can be trained to consider not only input key phrases (e.g., prompts) for virtual diagram generation (e.g., image generation and/or diagram generation, depending on diagram format), but user preference data within user data 390. For example, the virtual diagram generation module 399 can be trained on user preferences such as font types, color schemes, wording preferences, and diagrammatic preferences. As an example of supervised learning, the virtual diagram generation module 399 can be provided, as labeled input data, a generated virtual diagram for a first user (e.g., generated by an ML administrator or the first user themselves within diagramming software). The labeled input data can also include user data 390 associated with the first user, such as font preferences, color schemes, wording preferences, and diagrammatic preferences. As such, the virtual diagram generation module 399 can be trained on a corpus of labeled input virtual diagrams associated with specific users having specific user data 390. Thus, upon being trained, the virtual diagram generation module 399 can be configured to generate new virtual diagrams for new users based on their user data 390. The virtual diagram generation module 399 can also be trained in a semi-supervised, unsupervised, and/or reinforcement learning framework.

The virtual diagram display module 330 can be configured to cause virtual diagrams to be displayed to users (e.g., participants of a web conference), such as via clients 355 through web conferencing software 360-1. The virtual diagram display module 330 can be configured to cause virtual diagrams to be shared via integration into presentation materials that are screen shared, via display within web conferencing software 345 and 360, via one or more client-side applications (e.g., a multimedia application or virtual diagram generation software 347 and 365-2), or in any other suitable manner. Virtual diagrams can be generated and displayed to specific users or user groups at discrete timings. In embodiments, virtual diagrams can be generated/displayed in real-time or upon conclusion of a web conference. In embodiments, virtual diagrams can be populated in real-time. That is, a virtual diagram may begin to be displayed to a user before it is completed (e.g., flowchart steps may be incrementally added while a conversation is occurring during a web conference). In embodiments, virtual diagrams can be presented to users in a finalized form (e.g., a flowchart is presented to a user after discussing a given process). However, any suitable manner for presenting virtual diagrams to users can be implemented without departing from the spirit and scope of the present disclosure.

Table 1, shown below, depicts exemplary virtual diagram generation, in accordance with embodiments of the present disclosure.

TABLE 1
Example of virtual diagram generation and display

| User Data | User 1 | User 2 | User 3 | User 4 |
|---|---|---|---|---|
| Name | Richard | Emily | Gus | Rebecca |
| Role | Engineer | Sales | Management | Marketing |
| Application | Coding Platform | VISIO ® | MONDAY.COM ® | POWERPOINT ® |
| Preference | | | | |
| Extracted Key | “Integrate the | “Product A | “Updated | Please update |
| Phrases | following | Market Size: | Training Protocol | our Marketing |
| | Functionalities | 10M” | for New Hires: | strategies to |
| | into the new | “Competitor X | Step 1: A | include |
| | Code: | Sales: 10,000” | Step 2: B | strategies for |
| | Function A | “Competitor Y | Step 3: C | the following |
| | Function B | Sales: 5,000” | Step 4: D” | demographics |
| | Function C | “Competitor Z | | “Demographic |
| | Function D” | Sales: 7,500” | | A -Strategy A |
| | “Program A is | | | Demographic |
| | dependent on | | | B - Strategy B |
| | outputs from | | | Demographic |
| | Programs B and | | | C - Strategy C” |
| | C” | | | |
| Virtual Diagram | Tree & | Pie Chart | Gantt Chart | Knowledge |
| Preferences | Dependency | | | Graph (KG) |
| | Graph | | | |
| Font Format | Times New | Arial | Calibri | Helvetica |
| Preferences | Roman | | | |
| Virtual Diagram | Code Tree | Pie Chart of | Gantt Chart | Knowledge |
| Output | showing | Competitor | Indicating | Graph |
| | Functions and | Sales | Timeline for | Interrelating |
| | Dependency | | Training Protocol | Demographics |
| | Graph showing | | | with |
| | Program | | | Corresponding |
| | Dependency | | | Strategies |

As shown in Table 1, virtual diagrams are generated for four respective users. Each user has a unique role, application preference, font preference, and virtual diagram preference. A set of key phrases are extracted from speech data 392 associated with a web conference held on a web conferencing server 340. The key phrases extracted for each user are unique to each user's role. For example, speech utterances related to code functions and program dependencies are extracted for the user “Richard” based on the role “Engineer.” As another example, speech utterances related to market size and competitor sales are extracted for the user “Emily” based on the role “Sales.” Unique key phrases are also extracted for users “Gus” and “Rebecca” based on their unique user roles. Key phrases extraction can be completed in the same, or a substantially similar manner, as discussed with respect to key phrase extractor 320 of FIG. 3. For example, a key phrase extraction ML model 397 can be configured to extract key phrases for each respective user from a corpus of speech data 392.

A virtual diagram output result is also depicted in Table 1. For example, the first user “Richard” receives two virtual diagram outputs based on his user data 390, a first graph “Code Tree Showing Functions” and a second graph “Dependency Graph Showing Program Dependency.” The additional users also receive custom, personalized, virtual diagram outputs as depicted in Table 1. The virtual diagrams can be generated in the same, or a substantially similar manner, as discussed with respect to the virtual diagram generator 325 of FIG. 3. For example, virtual diagram generation model 399 can be used to generate each virtual diagram of Table 1. Each generated virtual diagram can be displayed in real-time during a web conference, or upon conclusion of a web conference.

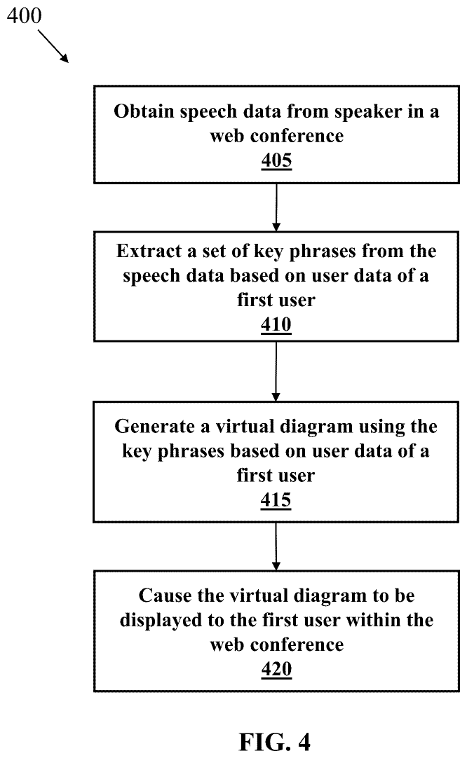

Referring now to FIG. 4, shown is a flow-diagram of an example method 400 for virtual diagram management, in accordance with embodiments of the present disclosure. One or more operations of method 400 can be completed by one or more processing circuits (e.g., computer 101, devices 205, server 235, clients 355, VDMS 305, ML models 395, web conferencing server 340).

Method 400 initiates at operation 405, where speech data is obtained from a speaker in a web conference. The speech data can be the same as, or substantially similar to, speech data 392 discussed with respect to FIG. 3.

A set of key phrases are extracted from the speech data based on user data of a first user. This is illustrated at operation 410. Key phrases can be extracted in the same, or a substantially similar manner, as described with respect to the key phrase extractor 320 of FIG. 3.

A virtual diagram is generated using the set of key phrases based on user data of the first user. This is illustrated at operation 415. The virtual diagram can be generated in the same, or a substantially similar manner, as discussed with respect to the virtual diagram generator 325 of FIG. 3.

The virtual diagram is caused to be displayed to the first user within the web conference. This is illustrated at operation 420. The virtual diagram can be displayed in the same, or a substantially similar manner, as discussed with respect to the virtual diagram display module 330 of FIG. 3.

The aforementioned operations can be completed in any order and are not limited to those described. Additionally, some, all, or none of the aforementioned operations can be completed, while still remaining within the spirit and scope of the present disclosure.

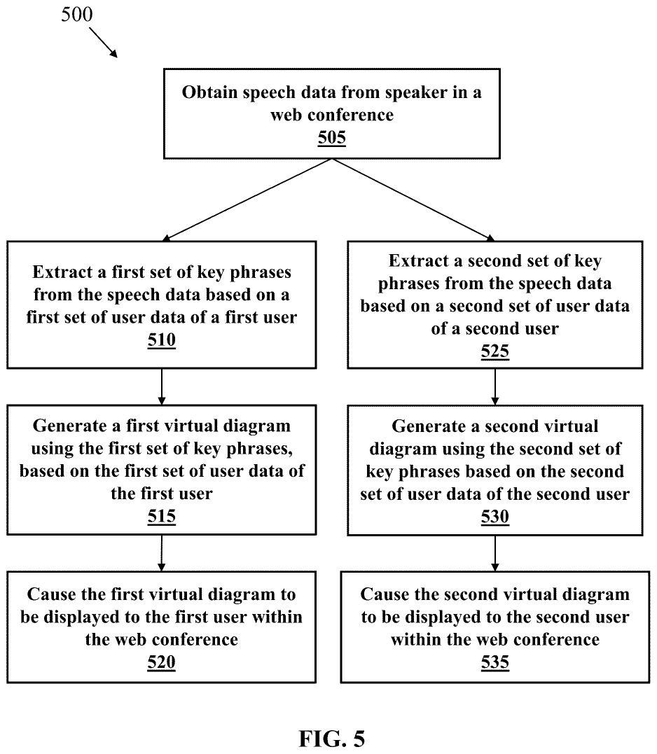

Referring now to FIG. 5, shown is a flow-diagram of another example method 500 for virtual diagram management, in accordance with embodiments of the present disclosure. One or more operations of method 500 can be completed by one or more processing circuits (e.g., computer 101, devices 205, server 235, clients 355, VDMS 305, ML models 395, web conferencing server 340).

Method 500 initiates at operation 505, where speech data of speaker in a web conference is obtained. The speech data can be the same as, or substantially similar to, speech data 392 described with respect to FIG. 3.

A first set of key phrases is extracted from the speech data based on a first set of user data of a first user. This is illustrated at operation 510. A second set of key phrases is extracted from the speech data based on a second set of user data of a second user. This is illustrated at operation 525. Key phrases can be extracted in the same, or a substantially similar manner, as described with respect to the key phrase extractor 320 of FIG. 3. The first and second sets of key phrases can be extracted in response to distinct conditions or based on distinct timings. For example, the first set of key phrases can be extracted in response to a first condition (e.g., detection of a first speech utterance) while the second set of key phrases can be extracted in response to a second condition (e.g., detection of a particular slide number).

A first virtual diagram is generated using the first set of key phrases based on the first set of user data of the first user. This is illustrated at operation 515. The first virtual diagram can be generated in the same, or a substantially similar manner, as described with respect to the virtual diagram generator 325 of FIG. 3. A second virtual diagram is generated using the second set of key phrases based on the second set of user data of the second user. This is illustrated at operation 530. The second virtual diagram can be generated in the same, or a substantially similar manner, as described with respect to the virtual diagram generator 325 of FIG. 3.

The first virtual diagram is caused to be displayed to the first user within the web conference. This is illustrated at operation 520. The second virtual diagram is caused to be displayed to the second user within the web conference. This is illustrated at operation 535. The first and second virtual diagrams can be displayed in the same, or a substantially similar manner, as discussed with respect to the virtual diagram display module 330 of FIG. 3.

The aforementioned operations can be completed in any order and are not limited to those described. Additionally, some, all, or none of the aforementioned operations can be completed, while still remaining within the spirit and scope of the present disclosure.

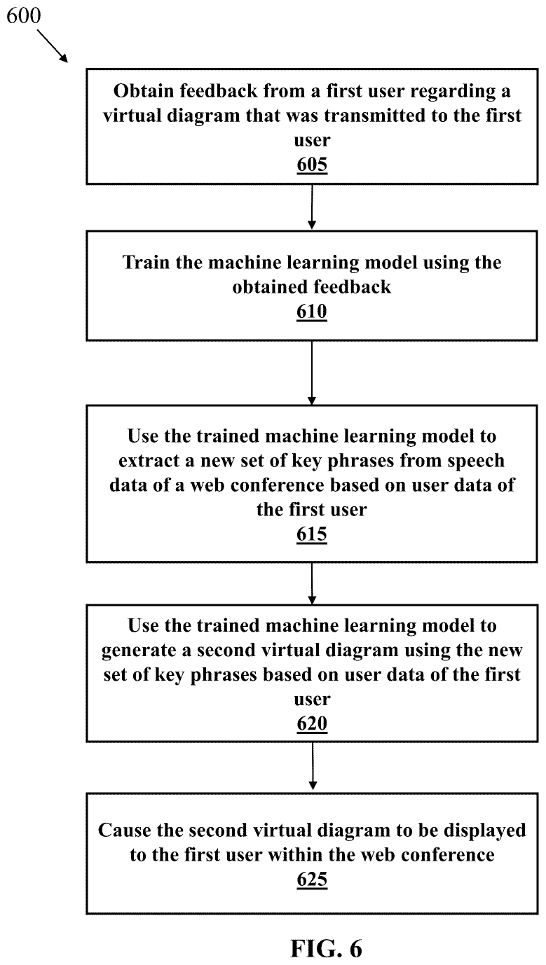

Referring now to FIG. 6, shown is a flow-diagram of an example method 600 for training one or more machine learning models for virtual diagram generation, in accordance with embodiments of the present disclosure. One or more operations of method 600 can be completed by one or more processing circuits (e.g., computer 101, devices 205, server 235, clients 355, VDMS 305, ML models 395, web conferencing server 340).

Method 600 initiates at operation 605, where feedback from a first user regarding a virtual diagram that was transmitted to the first user is obtained. Feedback can be obtained in any suitable manner. For example, the user can input feedback regarding a virtual diagram on a GUI. The feedback can indicate their relative satisfaction with the generated virtual diagram (e.g., satisfied, neutral, dissatisfied, among other types of feedback). Feedback can be obtained regarding various features associated with a virtual diagram, including the font, wording (e.g., included text, such as extracted key phrases), diagram type, color scheme, and other features.

The machine learning model is trained using the obtained feedback. This is illustrated at operation 610. Training the machine learning model can include inputting the feedback into one or machine learning pipelines the machine learning model includes. For example, if a user indicates poor word choice or topics included in the virtual diagram, negative feedback can be issued to a key phrase extraction module configured to extract key phrases to be included in the virtual diagram. As another example, if a user indicates that the graph is not in a preferred format, negative feedback can be issued to a virtual diagram generation model (e.g., virtual diagram generation model 399). The feedback generally adjusts parameter weights within ML model(s) that the feedback is relevant to. As such, negative feedback can reduce the likelihood of similar outputs for the user in the future while positive feedback can increase the likelihood of similar outputs for the user in the future. In embodiments, training can be completed by ML model training module 335 of FIG. 3.

The trained machine learning model is used to extract a new set of key phrases from speech data of a web conference based on user data of the first user. This is illustrated at operation 615. The trained machine learning model is used to generate a second virtual diagram using the new set of key phrases based on the user data of the first user. This is illustrated at operation 620. The second virtual diagram is caused to be displayed to the first user within the web conference. This is illustrated at operation 625. Displaying the second virtual diagram to the first user can be completed in the same, or a substantially similar manner, as discussed with respect to the virtual diagram display module 330 of FIG. 3. In embodiments, feedback can be requested any time a virtual diagram is generated and presented to a user for the purpose of training one or more machine learning models. Thus, upon conclusion of operation 625, additional feedback can be requested regarding the second virtual diagram.

The aforementioned operations can be completed in any order and are not limited to those described. Additionally, some, all, or none of the aforementioned operations can be completed, while still remaining within the spirit and scope of the present disclosure.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to those skilled in the art. Therefore, it is intended that the following claims be interpreted as covering all such alterations and modifications as fall within the true spirit and scope of the disclosure.

What is claimed is:

1. A computer-implemented method comprising:
obtaining speech data from a speaker within a web conference;
extracting a set of key phrases from the speech data within the web conference based on a first set of user data associated with a first user;
generating a virtual diagram using the set of key phrases, wherein the virtual diagram is generated based on the first set of user data; and
causing the virtual diagram to be displayed to the first user within the web conference.

2. The method of claim 1, further comprising:
extracting a second set of key phrases from the speech data within the web conference based on a second set of user data associated with a second user;
generating a second virtual diagram using the second set of key phrases, wherein the second virtual diagram is generated based on the second set of user data; and
causing the second virtual diagram to be displayed to the second user within the web conference.

3. The method of claim 1, wherein the extracting is completed by a machine learning model trained to extract key phrases from speech data based on user data.

4. The method of claim 3, further comprising:
obtaining feedback from the first user regarding the set of key phrases; and
training the machine learning model based on the obtained feedback.

5. The method of claim 4, further comprising:
extracting, using the trained machine learning model, a new set of key phrases from additional speech data within a second web conference based on the first set of user data associated with the first user;
generating a second virtual diagram using the new set of key phrases, wherein the second virtual diagram is generated based on the first set of user data; and
causing the second virtual diagram to be displayed to the first user within the second web conference.

6. The method of claim 1, wherein the generating is completed by a machine learning model trained to generate virtual diagrams using extracted key phrases based on user data.

7. The method of claim 6, further comprising:
obtaining feedback from the first user regarding the virtual diagram; and
training the machine learning model based on the obtained feedback.

8. The method of claim 7, further comprising:
extracting a new set of key phrases from additional speech data within a second web conference based on the first set of user data associated with the first user;
generating, using the trained machine learning model, a second virtual diagram using the new set of key phrases, wherein the second virtual diagram is generated based on the first set of user data; and
causing the second virtual diagram to be displayed to the first user within the second web conference.

9. A system comprising:
a processor set; and
one or more computer readable storage media; and
program instructions stored on the one or more computer readable storage media to cause the processor set to perform operations comprising:
obtaining speech data from a speaker within a web conference;
extracting a set of key phrases from the speech data within the web conference based on a first set of user data associated with a first user;
generating a virtual diagram using the set of key phrases, wherein the virtual diagram is generated based on the first set of user data; and
causing the virtual diagram to be displayed to the first user within the web conference.

10. The system of claim 9, wherein the operations further comprise:
extracting a second set of key phrases from the speech data within the web conference based on a second set of user data associated with a second user;
generating a second virtual diagram using the second set of key phrases, wherein the second virtual diagram is generated based on the second set of user data; and
causing the second virtual diagram to be displayed to the second user within the web conference.

11. The system of claim 9, wherein the extracting is completed by a machine learning model trained to extract key phrases from speech data based on user data.

12. The system of claim 11, wherein the operations further comprise:
obtaining feedback from the first user regarding the set of key phrases; and
training the machine learning model based on the obtained feedback.

13. The system of claim 12, wherein the operations further comprise:
extracting, using the trained machine learning model, a new set of key phrases from additional speech data within a second web conference based on the first set of user data associated with the first user;
generating a second virtual diagram using the new set of key phrases, wherein the second virtual diagram is generated based on the first set of user data; and
causing the second virtual diagram to be displayed to the first user within the second web conference.

14. The system of claim 9, wherein the generating is completed by a machine learning model trained to generate virtual diagrams using extracted key phrases based on user data, wherein the operations further comprise:
obtaining feedback from the first user regarding the virtual diagram;
training the machine learning model based on the obtained feedback;
extracting a new set of key phrases from additional speech data within a second web conference based on the first set of user data associated with the first user;
generating, using the trained machine learning model, a second virtual diagram using the new set of key phrases, wherein the second virtual diagram is generated based on the first set of user data; and
causing the second virtual diagram to be displayed to the first user within the second web conference.

15. A computer program product comprising:
one or more computer readable storage media; and
program instructions stored on the one or more computer readable storage media to perform operations comprising:
obtaining speech data from a speaker within a web conference;
extracting a set of key phrases from the speech data within the web conference based on a first set of user data associated with a first user;
generating a virtual diagram using the set of key phrases, wherein the virtual diagram is generated based on the first set of user data; and
causing the virtual diagram to be displayed to the first user within the web conference.

16. The computer program product of claim 15, wherein the operations further comprise:
extracting a second set of key phrases from the speech data within the web conference based on a second set of user data associated with a second user;
generating a second virtual diagram using the second set of key phrases, wherein the second virtual diagram is generated based on the second set of user data; and
causing the second virtual diagram to be displayed to the second user within the web conference.

17. The computer program product of claim 15, wherein the extracting is completed by a machine learning model trained to extract key phrases from speech data based on user data, wherein the operations further comprise:
obtaining feedback from the first user regarding the set of key phrases;
training the machine learning model based on the obtained feedback;
extracting, using the trained machine learning model, a new set of key phrases from additional speech data within a second web conference based on the first set of user data associated with the first user;
generating a second virtual diagram using the new set of key phrases, wherein the second virtual diagram is generated based on the first set of user data; and
causing the second virtual diagram to be displayed to the first user within the second web conference.

18. The computer program product of claim 15, wherein the generating is completed by a machine learning model trained to generate virtual diagrams using extracted key phrases based on user data.

19. The computer program product of claim 18, wherein the operations further comprise:
obtaining feedback from the first user regarding the virtual diagram; and
training the machine learning model based on the obtained feedback.

20. The computer program product of claim 19, wherein the operations further comprise:
extracting a new set of key phrases from additional speech data within a second web conference based on the first set of user data associated with the first user;
generating, using the trained machine learning model, a second virtual diagram using the new set of key phrases, wherein the second virtual diagram is generated based on the first set of user data; and
causing the second virtual diagram to be displayed to the first user within the second web conference.
